(19) United States
(12) Patent Application Publication
(10) Pub. No.: US 2017/0120132 A1
(43) Pub. Date: May 4, 2017

(54) REAL-TIME BALL TRACKING METHOD, SYSTEM, AND COMPUTER READABLE STORAGE MEDIUM FOR THE SAME

(71) Applicant: INDUSTRIAL BANK OF KOREA, Seoul (KR)

(72) Inventors: Pilsoon SHIN, Busan (KR); Jongman Kwon, Gwangju-si (KR)

(21) Appl. No.: 14/926,992

(22) Filed: Oct. 29, 2015

(51) Int. Cl. A63B 71/06; H04N 7/18; A63B 43/00; H04N 5/76; H04W 4/02; G01S 5/02; H04B 1/69; H04N 5/247

(52) U.S. Cl. CPC A63B 71/0619; H04B 1/69; H04N 7/181; H04N 5/247; H04N 5/76; H04W 4/023; G01S 5/0294; A63B 43/004

(57) ABSTRACT

A real-time ball tracking method and system using an ultra wideband (UWB) tag and an access point, and a computer readable storage medium for the same are provided. The real-time ball tracking system and method measures position information of each tag through UWB communication between a plurality of tags and a plurality of access points arranged in a ball tracking space, processes the measured position information in a management server, and displays the position information by mapping real-time position information to a virtual ball tracking space in a manager terminal.

### BACKGROUND

1. Field of the Invention

The present invention relates to a real-time ball tracking method and system using an ultra wideband (UWB) tag and an access point, and a computer readable storage medium for the same.

2. Discussion of Related Art

Due to developments in information communication technology such as data processing technology, when training for a ball game using a ball such as a football, a basketball, a baseball, a volleyball, an analysis system utilizing a camera is being widely used. For example, Sony corporation's Hawkeye which is applied in the English premier league includes a plurality of cameras arranged around a stadium, and is used for analyzing image information collected through the plurality of cameras when training. The image information collected through the cameras is utilized for accurate judgment of an actual game or to realize relay broadcasting. Further, according to Article dated Oct. 13, 2014, Zebra, “serve every movement of NFL players by RFID technology” (http://www.industrysolutions.co.kr/), Zebra technologies disclose a fact that a radio frequency identification (RFID) transmits an ultra wideband (UWB) signal which is 6.35 GHz to 6.75 GHz 25 times per second and has a reading distance of about 100 m in a UWB RFID system installed in 17 American football stadiums across the U.S.

However, according to the disclosure of the Zebra technologies, frequent interferences can occur in the process of transmission of the RFID since a plurality of RFIDs transmit a signal in a very rapid time interval in a limited area, and there is a limitation in which additional information besides a position signal cannot be measured.

Among prior art documents related to this technological field, International Patent Publication No. WO2011028383 (Monitoring and tracking athletic activity) discloses a method of performing an exercise activity while being tracked and monitored and a computer-readable medium for the same, and describes a configuration of receiving physical activity data with respect to a user, receiving a user selection with respect to a first place among a plurality of places displayed on an interface, and visually updating an amount of kinetic activity. However, the International Patent Publication No. WO2011028383 (Monitoring and tracking athletic activity) discloses technology implementing a function described above in a client device, and there is a limitation in which the technology cannot be applied to the condition described above since a conventional positioning system such as a global positioning system (GPS) is utilized for individual use of a user.

Even according to other conventional arts, since most technologies are mostly applied to ball game sports in a viewpoint of processing and utilizing motion information rather than position information, technology for improving an efficiency of a system for applying to the environment described above is required, and the inventor of the present invention proposes technology applying a UWB communication method to a ball tracking system and a method thereof.

### SUMMARY OF THE INVENTION

The present invention is directed to a real-time ball tracking system and method which measures position information of each tag through ultra wideband (UWB) communication between a plurality of tags and a plurality of access points arranged in a ball tracking space, processes the measured position information in a management server, and displays the position information by mapping real-time position information to the ball tracking space in a manager terminal.

Further, the present invention is directed to a real-time ball tracking system and method which integrally provides image information, biometric information, and motion information related to each tag as well as position information by each tag, and minimizes interference between tags.

According to one aspect of the present invention, there is provided a real-time ball tracking system, including a first number of tags configured to transmit a UWB signal to respective access points according to a scheduled period, a second number of access points arranged to be spaced apart from each other in a ball tracking space, and configured to receive the UWB signal transmitted from the first number of tags, a management server configured to receive the UWB signal transmitted from each of the access points through a communication network, and calculate position information of each of the first number of tags, and a manager terminal configured to receive the position information from the management server through the communication network, and display the positing information by mapping the position information in real time on image data according to the ball tracking space, wherein the first number is an integer which is greater than 1, and the second number is an even number which is equal to or more than 4.

At least one among the first number of tags may be installed in a ball, and the tags excluding the tag installed in the ball among the first number of tags may be worn or attached to a body or clothing of a player.

Also, the first number of tags may transmit the UWB signal within periods which are separated, respectively, based on a clock synchronization packet (CSP) transmitted from at least one of the second number of access points and an inherent value allocated to each of the first number of tags.

Further, the real-time ball tracking system may further include a capturing device including a third number of camera modules configured to capture a predetermined area toward the ball tracking space, and a communication unit configured to transmit image information captured by each of the camera modules to the management server through the communication network, and the communication unit of the capturing device may receive position information of each of the first number of tags from the management server, and each of the camera modules of the capturing device may include a pan motor and a tilt motor.

Moreover, the capturing device may further include a pan sensor configured to detect a reference position of the pan motor to rotate the camera module left and right, a tilt sensor configured to detect a reference position of the tilt motor to move the camera module up and down, and a driving unit configured to drive the pan motor and the tilt motor of the camera module adjacent to a position corresponding to the position information of the tag selected in the manager terminal.

Meanwhile, the manager terminal may further display image information with respect to the tag selected among the displayed position information

The tags excluding the tag installed in the ball among the first number of tags may be worn or attached to a body or clothing of a player together with a sensor module, and the sensor module may include, a biometric sensor configured to measure at least one biometric information among a heart rate, a respiration, and a temperature, a motion sensor configured to sense a speed and acceleration of the player to which the tag is attached as motion information, and a communication unit configured to transmit the measured biometric information and the sensed motion information to the management server through the communication network.

When the system includes a sensor module, the management server may transmit the biometric information and the motion information by associating it with the position information to the manager terminal, and the manager terminal may analyze the biometric information and the motion information with respect to the selected tag among the displayed position information, and additionally display the position information in a two-dimensional or a three-dimensional graph form.

In the real-time ball tracking system, the communication network may be any one of a third-generation (3G) network, a long term evolution (LTE) network, wireless-fidelity (Wi-Fi) network.

According to another aspect of the present invention, there is provided a real-time ball tracking method, including, transceiving a UWB signal between a first number of tags and a second number of access points and tracking a position of each of the first number of tags in real time, transmitting position information with respect to each of the first number of tags to a manager terminal through a management server, and displaying the position information by mapping the position information received from the management server in real time on image data according to a ball tracking space.

The tracking of the position of each of the tags may transmit the UWB signal within respective periods which are separated based on a CSP transmitted from at least one of the second number of access points and an inherent value allocated to each of the first number of tags.

Also, the real-time ball tracking method may further include receiving image information capturing a predetermined area in the ball tracking space from a camera module through the management server, wherein the displaying the position information by mapping position information selectively displays image information by adding on image data according to the ball tracking space.

Further, the real-time ball tracking method may further include receiving biometric information and motion information from a sensor module associated with some of the first number of tags through the management server, wherein the displaying the position information by mapping position information analyzes the position information by adding the biometric information and the motion information on image data according to the ball tracking space, and selectively displays the position information in a two-dimensional or a three-dimensional graph form.

According to still another aspect of the present invention, there is provided a computer readable storage medium storing a computer program for executing a method according to the present. The computer program may include an instruction for transceiving a UWB signal between the first number of tags and the second number of access points and tracking a position of each of the first number of tags in real time, an instruction for transmitting position information with respect to each of the first number of tags to a manager terminal through a management server, and an instruction for displaying the position information by mapping the position information received from the management server in real time on image data according to a ball tracking space.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a diagram illustrating a configuration of a real-time ball tracking system according to an embodiment of the present invention;

FIG. 2 is a functional diagram illustrating some components of a real-time ball tracking system according to an embodiment of the present invention;

FIG. 3 is a flowchart for describing a ball tracking method according to one embodiment of the present invention;

FIG. 4 is a flowchart for describing a ball tracking method according to another embodiment of the present invention;

FIG. 5 is a timing diagram for describing an operation in which a signal is transceived between a plurality of ultra wideband (UWB) tags and some access points in a real-time ball tracking method and system according to an embodiment of the present invention;

FIG. 6A is a diagram illustrating an exemplary image of a real ball tracking space in which an embodiment of the present invention is implemented, and FIG. 6B is a diagram illustrating a virtual ball tracking space output from a terminal in a system and method according to an embodiment of the present invention; and

FIGS. 7 and 8 are diagrams illustrating exemplary images output from a manager terminal which is a component in a system and method according to an embodiment of the present invention.

### DETAILED DESCRIPTION OF EXEMPLARY EMBODIMENTS

Hereinafter, a real-time ball tracking method and system utilizing an ultra wideband (UWB) tag and an access point according to exemplary embodiments of the present invention will be described with reference to the accompanying drawings.

It will be further understood that the terms “comprises,” “comprising,” “includes,” and/or “including,” when used herein, specify the presence of stated features, integers, steps, operations, elements, and/or components, but do not preclude one or more other features, integers, steps, operations, elements, components, and/or equivalents thereof. Further, the singular forms “a”, “an,” and “the” are intended to include the plural forms as well, unless the context clearly indicates otherwise. That is, the terms “comprises,” “comprising,” “includes,” and/or “including,” do not preclude the presence or addition of one or more other features, integers, steps, operations, elements, components, and/or groups thereof.

As used herein, it will be understood that, although the terms “first,” “second,” etc. may be used herein to describe various elements, these elements should not be limited by these terms. These terms are only used to distinguish one element from another. For example, a first element could be termed a second element, and, similarly, a second element could be termed a first element, without departing from the scope of the inventive concept.

As used herein, the term “access point” may be a fixed station used for communicating with access terminals, be referred to as a node, an evolved node B (eNodeB), a home enhanced node B (HeNB), or another term, and it should be understood that the access point is referring to various objects having a function of communicating with terminals regardless of terms which are referred to on a market such as a random access point, a relay access point, a router access point, etc.

As used herein, the term “terminal” may be an object which is referred to as a technological term such as a mobile station (MS), a mobile terminal (MT), a subscriber station, a portable/mobile subscribed station, a user equipment (UE), an access terminal (AT), etc., and may be an electronic communication device for a user including some or all of the MS, the MT, the subscriber station, the UE, the AT, etc.

Further, all technical terms used herein may be used by selecting general technical terms which are commonly used, but in some cases, may be terms which are arbitrarily selected, and in this case, terms should be understood as being interpreted by considering their meanings in the context described in the specification rather than being limited to names of the terms.

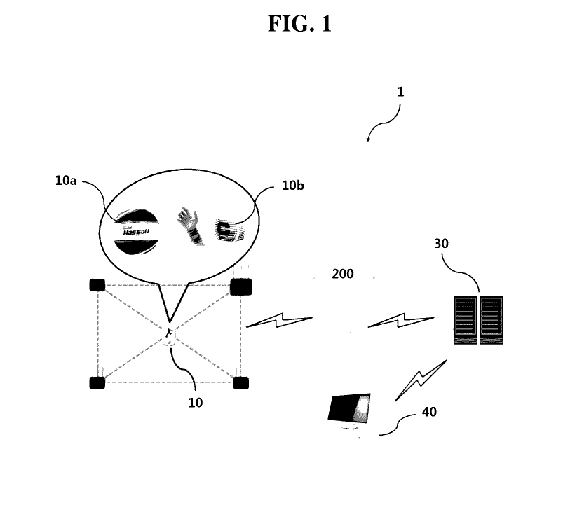

FIG. 1 is a diagram illustrating a configuration of a real-time ball tracking system 1 according to an embodiment of the present invention. A real tracking space according to a “ball tracking system” disclosed in this specification according to the present invention may refer to a stadium for training, or a real game, access points 20 may be arranged to be spaced apart from each other in an outermost area, and receive signals form a plurality of UWB tags. In FIG. 1, an example in which four access points 20 are arranged is illustrated, but the number of the access points may be 4, 6, 8, and 10, etc., that is, the number of the access points may be properly set to have the number needed for measuring the position according to a specification of a system.

A UWB tag 10 for transceiving a UWB signal with the access point 20 may track a position of each tag by a relationship of the signals transceived between the UWB tag 10 and the access point 20 by transceiving the UWB signal with the access point 20 according to a scheduled period.

One or more tags 10a (a first UWB tag) among the plurality of UWB tags 10 may have a form capable of being installed inside a ball or being detachable from an outer surface of the ball. Other tags 10b (a second UWB tag) excluding the first UWB tag 10a may be attached to or worn on a body or clothes of a player. As shown in FIG. 1, the tag 10 may be implemented in the form of a wrist guard which is worn on a wrist of the player, and also have a form which is worn on various body parts such as wrists, thighs, a waist, etc.

A signal transceiving relationship between the plurality of UWB tags 10 and the access points 20 may be transmitted to the management server 30 through a communication network 200. The communication network 200 may be a data communication method capable of expanding coverage through another relay station, relay base, a base station, etc., and transceiving a large amount of data at high speed, and for example, be one among a third generation (3G) network, a long term evolution (LTE) network, and wireless-fidelity (Wi-Fi) network.

The management server 30 may monitor the position of each of the plurality of UWB tags 10 based on the relationship between the UWB tag 10 and the access point 20. In some cases, the position of each tag 10 may be measured in some specific access points such as a master access point 20 among the plurality of access points 20.

Meanwhile, when the management server 30 finds position information of the UWB tag 10, the position information is output on a manager terminal 40 by overlapping the position information on an image matched with the real ball tracking space. Not only may the image information with respect to the UWB tag 10 be additionally output, but information measured through a biometric sensor and a motion sensor may also be additionally output (not shown). The additional aspects will be described with reference to the accompanying drawings.

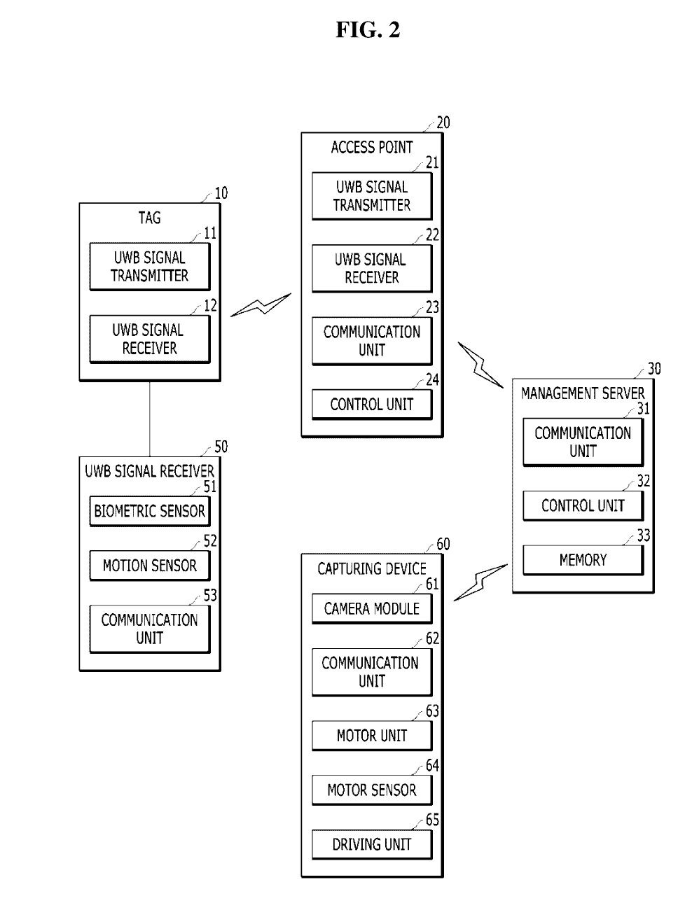

FIG. 2 is a functional diagram illustrating some components of a real-time ball tracking system according to an embodiment of the present invention.

A first number of the tags 10 may be included in the ball tracking space according to the present invention. In order to identify a position of the tag 10, each tag may include a UWB signal transmitter 11 and a UWB signal receiver 12. Each of the access points 20 may also include a UWB signal transmitter 21 and a UWB signal receiver 22. Measuring a time interval between transceived signals based on an interval scheduled between the tag 10 and the access point 20 by a UWB signal transceiver.

The access point 20 may further include a communication unit 23 and a control unit 24, the communication unit 23 may be configured to transceive data between the access point 20 and the management server 30, and additionally, be configured to transceive data with a sensor module 50, but when the sensor module 50 is directly communicating with the management server 30, the communication unit 23 may be configured to connect between the access point 20 and the management server 30.

The control unit 24 of the access point 20 may perform data processing required when forwarding a UWB signal relationship transceived in a relationship with the tag 10 to the management server 30, and the data processing may be performed as a method corresponding to that of the management server 30.

Meanwhile, the tag (that is, the tag illustrated as 10b in FIG. 1, and included in the form of being wearable on a body of a player) excluding the first tag (10a in FIG. 1) installed in a ball may be connected and associated with the sensor module 50. The sensor module 50 may include a biometric sensor 51 for measuring at least one biometric information among a heart rate, a respiration, and the temperature of a player to which the tag 10 is attached, a motion sensor 52 for sensing a speed or acceleration of the player to which the tag 10 is attached as motion information, and a communication unit 53 for transmitting the measured biometric information and the sensed motion information to the management server 30.

Additionally, the ball tracking system and method according to the present invention may further include a capturing device 60. The capturing device 60 may obtain image information around the tag 10, include a third number of camera modules 61 for capturing a predetermined area toward a stadium which is a real ball tracking space, and include a communication unit 62 for transmitting the image information captured by each camera module to the management server 30.

Further, a motor unit 63 for driving each camera module may be included. In this case, the capturing device 60 may be panned or tilted according to the position information measured by the tag 10 and the motion information sensed by the sensor module 50.

When the capturing device 60 further includes the motor unit 63, the capturing device 60 may further include a motor sensor 64 for detecting a reference position of a pan motor for rotating the camera module left and right, and detecting a reference position of a tilt motor for moving the camera module up and down, and a driving unit for driving the pan motor or the tilt motor of the camera module adjacent to a position corresponding to the position information of the tag selected by the manager terminal 40.

The management server 30 may include a communication unit 31 for performing data communication with each of the access point 20, the manager server 40, the sensor module 50, and the capturing device 60, and may also include a control unit 32 for performing a setting of a communication protocol with another component which performs data communication, a transceived data processing, and a processing of additional data added to an operation of the system. Further, the management server 30 may include a memory 33 for storing data generated and processed in the tracking system according to the present invention such as the image information, and sensor measurement data, etc., in addition to the processed position information

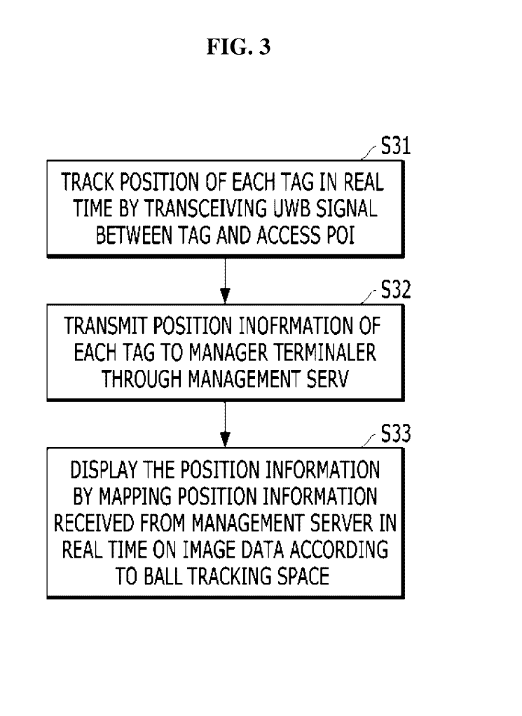

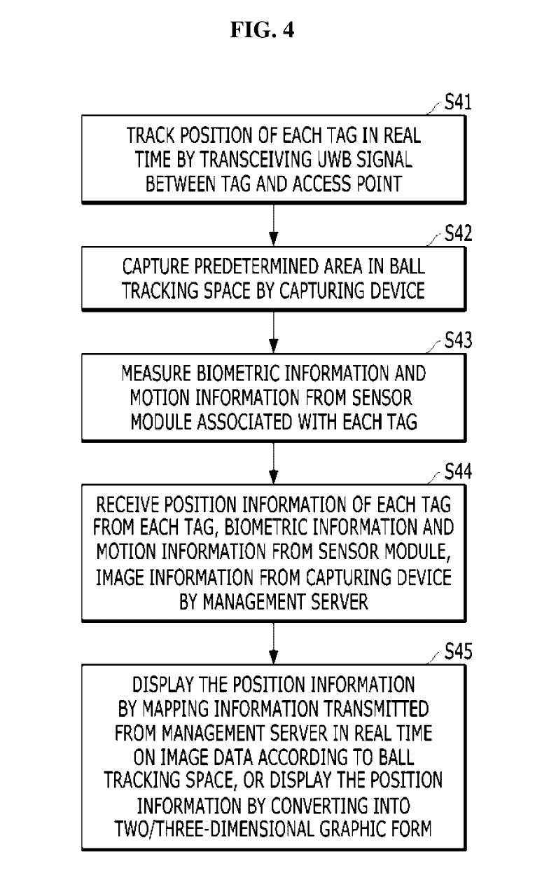

FIGS. 3 and 4 illustrate flowcharts for describing a ball tracking method according to an embodiment of the present invention, respectively, FIG. 3 illustrates a flowchart for describing a ball tracking method based on position information, and FIG. 4 illustrates a flowchart for describing a ball tracking method based on captured image information, biometric information, and motion information besides the position information.

First, referring to FIG. 3, the position of each tag may be tracked in real time by transceiving a UWB signal between a tag and an access point (operation S31). Position information of each tag may be transmitted to a manager terminal through a management server (operation S32), and the position information received from the management server may be displayed by being mapped on image data according to the ball tracking space in real time (operation S33).

As another embodiment, referring to FIG. 4, a position of each tag may be tracked in real time by transceiving a UBW signal between a tag and an access point (operation S41), which may be recognized to be similar or equal to the operation S31 shown in FIG. 3.

A predetermined area in a ball tracking space may be captured by a capturing device (operation S42), biometric information and motion information may be measured from a sensor module associated with each tag (operation S43). Here, the biometric information may mean at least one among a heart rate, a respiration, and a temperature of a player, and the motion information may mean information related to a speed and acceleration of a player, but are not limited thereto.

By the operations, position information of each tag may be received from each tag, biometric information and motion information may be received from each sensor module, and image information transmitted from each capturing device may be received by a management server (operation S44).

The management server may process the position information, the biometric information, the motion information, and the image information, and when the information is forwarded to a manager terminal, the manager terminal may map the information on image data according to the ball tracking space in real time, or display the position information by converting the information into a two-dimensional or three-dimensional graphic form (operation S45).

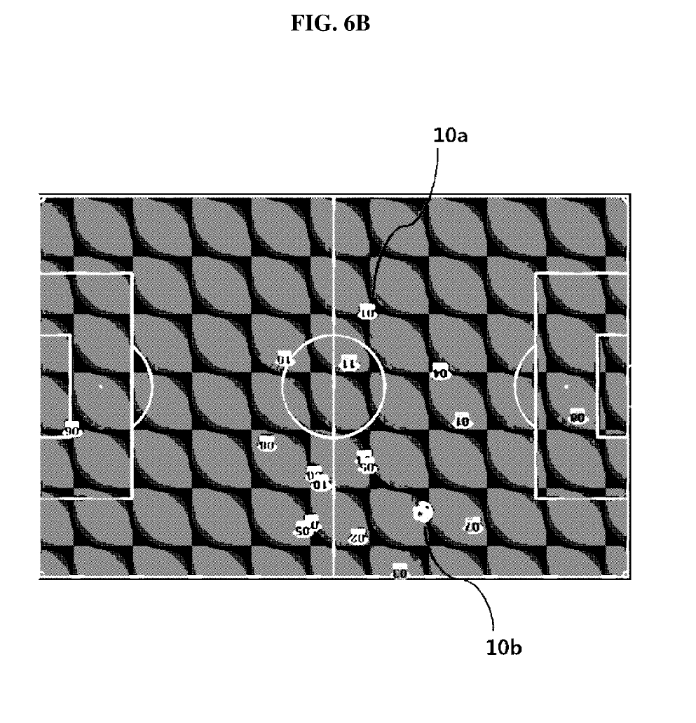

Like the operation S33 of FIG. 3 or the operation S45 of FIG. 4, an example in which the real time ball tracking method and system output to the manager terminal according to the present invention will be described in detail with reference to FIGS. 6A to 8.

FIG. 6A illustrates an exemplary image of a real ball tracking space in which the present invention is implemented, FIG. 6B illustrates a virtual ball tracking space output from a terminal by a system and method according to the present invention, and a position (for example, 10b) of a player shown in FIG. 6A may be output together with a position 10b of a ball on a two-dimensional space shown in FIG. 6B.

Position information of a player and a ball may be tracked and displayed in real time in the manager terminal by a signal transceiving relationship between UWB tags worn by players and attached to a ball and an access point included in a ball tracking space.

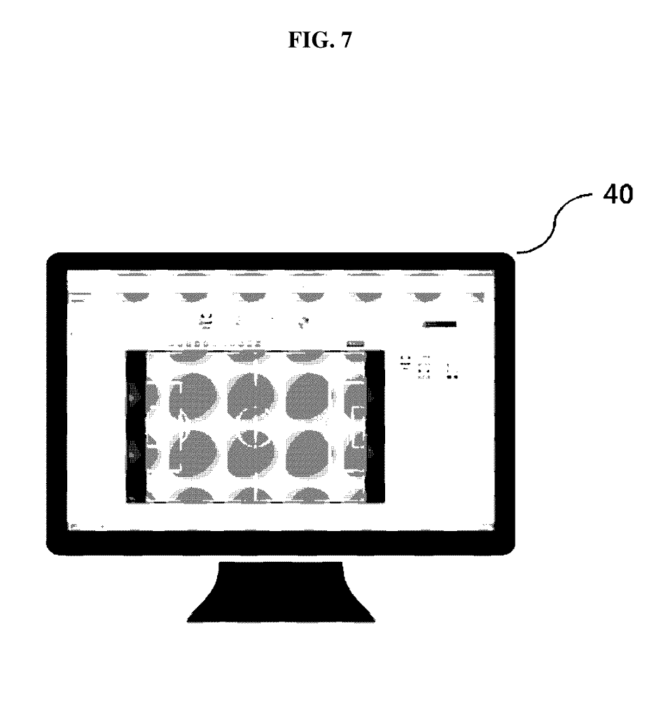

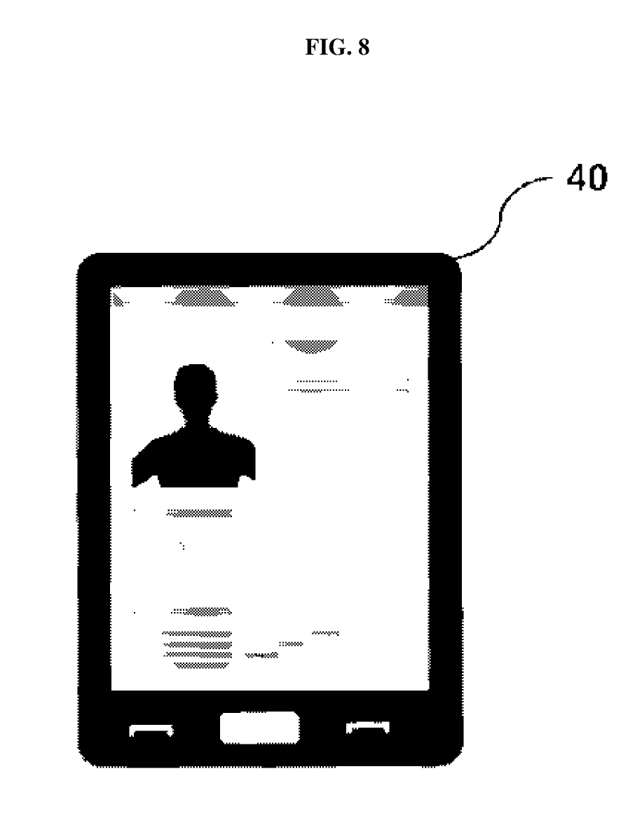

As described herein, the manager terminal 40 may be an electronic communication device capable of performing data communication and including an electrical display output means as a subscriber or user terminal regardless of its shape or its name, and may be a conventional personal computer (PC), an integrated PC, a notebook computer, etc. shown in FIG. 7, and be a tablet PC, a smart phone, etc. shown in FIG. 8.

As shown in FIG. 7, position information may be output in the ball tracking space, and also additional information related to the game itself may be output, and as shown in FIG. 8, an additional aspect pattern which is associated with image information, biometric information, and motion information may be output.

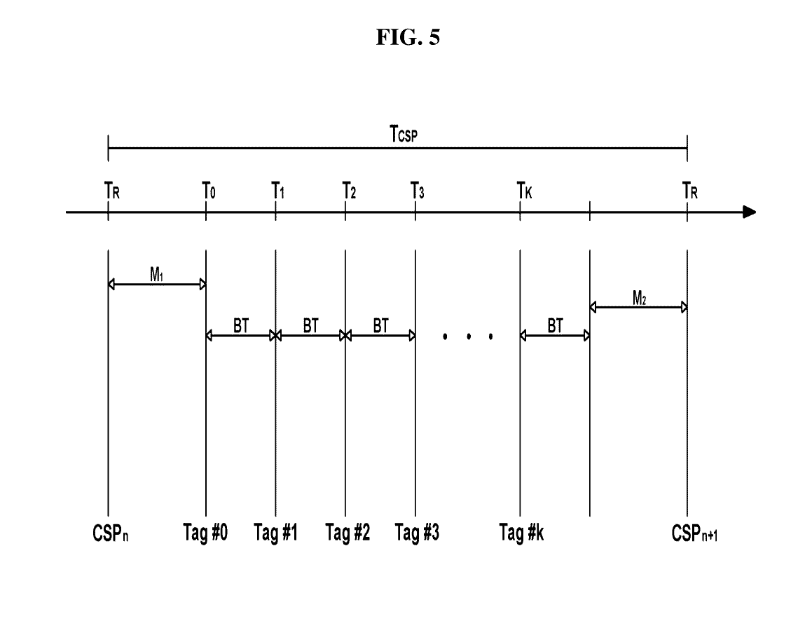

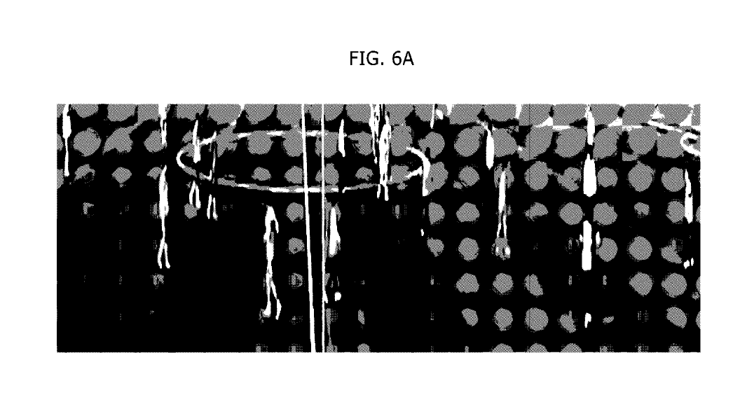

Meanwhile, an operation in which a signal is transceived in a relationship of UWB tags and an access point which are components in a ball tracking system and method according to an embodiment of the present invention will be described with reference to a timing diagram shown in FIG. 5.

FIG. 5 illustrating the timing diagram with reference to a detailed signal flow between the access point 20 and a plurality of UWB tags 10 will be referred to.

As shown, T_{R}, T₀, T₁, T₂, T₃, . . . , T_{K}, T_{K+1}, T_{R} are illustrated from a left side on a time axis, and the first displayed T_{R} shows a reference time in which a preceding clock synchronization packet CSPₙ with respect to each UWB tag is received from the access point, and the next displayed T_{R} shows a reference time in which a next order clock synchronization packet CSPₙ₊₁ is received from the access point. Referring to FIG. 5, a signal flow transceived between the access point and the plurality of UWB tags 20 at a time in which an n-th clock synchronization packet CSPₙ is received will be described in detail.

Before the n-th clock synchronization packet CSPₙ is received, each UWB tag may have an inherent value, and the inherent value of the tag may be specified by a specific access point specified as a master among access points or may be specified not by the access point specified as a separate master but a random access point. Further, each UWB tag may allocate its own inherent value by a signal exchange method.

For example, when 30 UWB tags are operated in the ball tracking space according to an embodiment of the present invention, inherent values from 0 to 29 or from 1 to 30 are allocated to each tag, and the inherent value may be specified to not overlap with respect to the UWB tags according to the range of the inherent values.

When the clock synchronization packet CSPₙ is received at the time T_{R}, a response packet (signal) may be transmitted to the access point during a period excluding an initial margin period M₁ and a final margin period M₂ among a period T_{CSP} according to the clock synchronization packet CSPₙ (that is, a blink term (BT) in which is inherently allocated to k UWB tags within a BTx).

As described above, assume that 30 UWB tags are operated in the ball tracking space according to the present invention, the inherent values from 0 to 29 are allocated to each tag, an entire period according to the clock synchronization packet is 100 ms, and an initial margin period M₁ is 10 ms.

Further, assume that the final margin period M₂ is 10 ms like the initial margin period M₁, since a BT is arithmetically calculated as

$$\frac{100 ms - ( 10 ms \times 2 )}{30} = 2.666 … ,$$

in this case, BTs of the UWB tags which are numbered from #0 to #4 may be as follows.

TABLE 1

| | starting time of BT | | ending time of BT |
|---|---|---|---|
| UWB #0 | 10 | ms | 12.6666 . . . ms |
| UWB #1 | 12.6666 . . . | ms | 15.3333 . . . ms |
| UWB #2 | 15.3333 . . . | ms | 17.9999 . . . ms |
| UWB #3 | 17.9999 . . . | ms | 20.6666 . . . ms |
| UWB #4 | 20.6666 . . . | ms | 23.3333 . . . ms |

The BT may be converted into an integer by a Gaussian symbol Equation, and each BT may be calculated as 2 ms. That is, the BT may be calculated by the following Equation in the ball tracking space according to the present invention.

$$BT = [ \frac{{T}_{CSP} - ( {M}_{1} + {M}_{L} )}{the Number of UWB Tags} ]$$

Here, M₁ and M_{L} represent an initial margin period and a final margin period with respect to a single clock synchronization packet, respectively, and denote a protective period in which a transmission of a response packet is not performed in any tag among a plurality of UWB tags during the periods. When each BT is determined as 2 ms by the Gaussian calculation shown in the above Equation, an i-th tag among the plurality of UWB tags may transmit a starting time and transmit its own response packet in M₁+(BT×(i−1)), and the i-th tag may start to transmit the response packet within the BT from the calculated transmission starting time.

The first UWB tag (which, in the example described above, is UWB #0, but the i value is defined as 1) may transmit the first response packet within the range of 10 to 12 ms after waiting until 10 ms, the second UWB tag (which, in the example described above, is UWB #1) may transmit a second response packet within the range of 12 ms to 14 ms after waiting until 12 ms, (in the same manner), the 29-th UWB tag (which, in the example described above, is UWB #28) may transmit a twenty ninth response packet within the range of 66 ms to 68 ms after waiting until 66 ms, and lastly, the 30-th UWB tag (which, in the example described above, is UWB#29) may transmit a thirtieth response packet within the range of 68 ms to 70 ms after waiting until 68 ms. Accordingly, the final margin period M_{L} may be 30 ms which is in the range from 70 ms to 100 ms which is a remaining period, and the final margin period M_{L} which is initially set may be adjusted from 10 ms to 30 ms.

According to the method described above, since the plurality of UWB tags configuring the real-time ball tracking system transmit response packets in different periods from each other, even when the number of the response packets which each UWB tag transmits increases as the number of UWB tags increases, the response packets transmitted from each UWB tag to the access point may not collide in the wireless area, and interference between them may be avoided.

Accordingly, according to the present invention, real-time position information may be provided in real time with an error range of 30 cm by applying a UWB precise positioning method to the real-time ball tracking system and method, and thus the real-time position information can be measured precisely, and a sport analysis solution capable of minimizing the interference occurring in the processing of communicating between the UWB tag and the access point can be provided. Further, according to the system and method of the present invention, an implementation cost can be reduced compared with a conventional camera-based tracking system.

Moreover, the present invention can integrally provide game analysis information such as a training distance, a pass success rate, and a ball possession rate, etc. of each player and each team by integrally providing the image information, the biometric information, and the motion information besides the position information.

Exemplary modules, logic blocks, means, steps, or a combination thereof related to exemplary embodiments described herein may be implemented by electronic hardware (a digital design designed by a coding, etc.), software (various applications including a program instruction), or a combination thereof. Implementation as any form of hardware and/or software may be changed according to design limitations imposed on the user terminal.

In another embodiment, one or more components described herein may be stored in a memory as a computer program instruction, and the method described herein may be performed by a digital signal processor which is able to execute the computer program instruction. The connections between the components specified with reference to the accompanying drawings herein are only an example, at least one portion of them may be omitted, and conversely, an additional component besides the components may be further included.

According to the present invention, real-time position information may be provided in real time with an error range of 30 cm by applying the UWB precise positioning method to the real time ball tracking system and method, and thus the real-time position information can be measured precisely, and a sport analysis solution capable of minimizing the interference occurring in the processing of communication between the UWB tag and the access point can be provided.

According to the system and method of the present invention, an implementation cost can be reduced compared with a conventional camera-based tracking system.

Moreover, the present invention can integrally provide game analysis information such as a training distance, a pass success rate, and a ball possession rate, etc. of each player and each team by integrally providing the image information, the biometric information, and the motion information besides the position information.

It may be understood by those of ordinary skill in the art that an effect according to the present invention is not limited to the effects described above.

While the embodiments of the present invention are described in detail above, the scope of the present invention is not limited by the exemplary embodiments of the present invention and the accompanying drawings. The scope of the present invention should be defined by the claims, and it is intended that the present invention covers all such modifications and changes of those of ordinary skill in the art derived from a basic concept of the appended claims, and their equivalents.

What is claimed is:

1. A real-time ball tracking system, comprising:
a first number of tags configured to transmit an ultra wideband (UWB) signal to respective access points according to a scheduled period;
a second number of access points arranged to be spaced apart from each other in a ball tracking space, and configured to receive the UWB signal transmitted from the first number of tags;
a management server configured to receive the UWB signal transmitted from each of the access points through a communication network, and calculate position information of each of the first number of tags; and
a manager terminal configured to receive the position information from the management server through the communication network, and display the position information by mapping the position information in real time on image data according to the ball tracking space,
wherein the first number is an integer which is greater than 1, and the second number is an even number which is equal to or more than 4.

2. The real-time ball tracking system of claim 1, wherein at least one among the first number of tags is installed in a ball, and the tags excluding the tag installed in the ball among the first number of tags are attached to a body or clothing of a player, or are worn.

3. The real-time ball tracking system of claim 2, wherein the first number of tags transmit the UWB signal within periods which are separated, respectively, based on a clock synchronization packet (CSP) transmitted from at least one of the second number of access points and an inherent value allocated to each of the first number of tags.

4. The real-time ball tracking system of claim 3, further comprising:
a capturing device including a third number of camera modules configured to capture a predetermined area toward the ball tracking space, and a communication unit configured to transmit image information captured by each of the camera modules to the management server through the communication network.

5. The real-time ball tracking system of claim 4, wherein the manager terminal further displays image information with respect to a tag selected among the displayed position information

6. The real-time ball tracking system of claim 5, wherein the communication unit of the capturing device receives the position information with respect to each of the first number of tags from the management server, and each of the camera modules of the capturing device includes a pan motor and a tilt motor.

7. The real-time ball tracking system of claim 6, wherein the capturing device further comprises:
a pan sensor configured to detect a reference position of the pan motor to rotate the camera module left and right;
a tilt sensor configured to detect a reference position of the tilt motor to move the camera module up and down; and
a driving unit configured to drive the pan motor and the tilt motor of the camera module adjacent to a position corresponding to the position information of the tag selected in the manager terminal.

8. The real-time ball tracking system of claim 2, wherein the tags excluding the tag installed in the ball among the first number of tags are attached to a body or clothing of a player, or are worn together with a sensor module,
wherein the sensor module includes:
a biometric sensor configured to measure at least one biometric information among a heart rate, a respiration, and a temperature;
a motion sensor configured to sense a speed and acceleration of the player to which the tag is attached as motion information; and
a communication unit configured to transmit the measured biometric information and the sensed motion information to the management server through the communication network.

9. The real-time ball tracking system of claim 8, wherein the management server transmits the biometric information and the motion information by associating it with the position information to the manager terminal, and the manager terminal analyzes the biometric information and the motion information with respect to the selected tag among the displayed position information, and additionally displays the position information a two-dimensional or a three-dimensional graph form.

10. The real-time ball tracking system of claim 1, wherein the communication network is any one of a third-generation (3G) network, a long term evolution (LTE) network, and a wireless-fidelity (Wi-Fi) network.

11. A method for tracking a ball in a real-time, comprising:
transceiving a UWB signal between a first number of tags and a second number of access points and tracking a position of each of the first number of tags in real time;
transmitting position information with respect to each of the first number of tags to a manager terminal through a management server; and
displaying the position information by mapping the position information received from the management server in real time on image data according to a ball tracking space.

12. The method of claim 11, wherein the tracking of the position of each of the tags transmits the UWB signal within each of periods which are separated based on a clock synchronization packet (CSP) transmitted from at least one of the second number of access points and an inherent value allocated to each of the first number of tags.

13. The method of claim 12, further comprising:
receiving image information capturing a predetermined area in the ball tracking space from a camera module through the management server,
wherein the displaying the position information by mapping position information selectively displays image information by adding on image data according to the ball tracking space.

14. The method of claim 12, further comprising:
receiving biometric information and motion information from a sensor module associated with some of the first number of tags through the management server,
wherein the displaying the position information by mapping position information analyzes the position information by adding the biometric information and the motion information on image data according to the ball tracking space, and selectively displays the position information in a two-dimensional or a three-dimensional graph form.

15. A computer readable storage medium storing a computer program for executing a method according to claim 11.

16. A computer readable storage medium storing a computer program for executing a method according to claim 12.

17. A computer readable storage medium storing a computer program for executing a method according to claim 13.

18. A computer readable storage medium storing a computer program for executing a method according to claim 14.
